(19) United States
(12) Patent Application Publication
(10) Pub. No.: US 2017/0278064 A1
(43) Pub. Date: Sep. 28, 2017

(54) METHOD, SYSTEM, AND DEVICE FOR DISTRIBUTION NETWORK

(71) Applicant: Jusda International Logistics (TAIWAN) CO.,LTD, Taoyuan (TW)

(72) Inventors: CHIA-LIN KAO, New Taipei (TW); FENG-TIEN YU, Taipei City (TW)

(21) Appl. No.: 15/080,844

(22) Filed: Mar. 25, 2016

(51) Int. Cl. G06Q 10/08; G01C 21/36; H04L 29/08

(52) U.S. Cl. CPC G06Q 10/08355; H04L 67/12; G01C 21/36

(57) ABSTRACT

A vehicle routing device includes a processor configured to perform an objective function. An input unit communicatively is coupled to the processor and configured to accept input of at least one of a vehicle information, a depot information, and a customer information. A computer readable medium is coupled to the processor and configured to receive the routing information, the computer readable medium further including instructions stored therein which, upon execution by the processor, causes the processor to perform operations.

### FIELD

The subject matter herein generally relates to system, device, and method for distribution network.

### BACKGROUND

Most retailers have restructured their procurement strategies from decentralized procurement through traditional wholesale markets to centralized procurement systems through their own distribution centers. The management team needs to choose an ideal distribution center location to minimize the opening, operational, and transportation costs. Logistical costs represent a large portion of company expenses. Distribution system design has become a major issue for many industries.

Generally, factory and/or warehouse locations should be addressed at a strategic level, while cargo vehicle routing must be targeted at a tactical or operational level to satisfy customer demand. Location and routing decisions are interdependent and concurrent.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1A is an illustration of an example distribution system.

FIG. 1B is another illustration of an example distribution system.

FIG. 2 is an illustration of an embodiment of a distribution network.

FIG. 3 is an illustration of an embodiment of a device to apply the network of FIG. 2.

FIG. 4 is a flowchart of an embodiment of a vehicle routing method.

FIG. 5 is a flowchart of another embodiment of a vehicle routing method.

FIG. 6 is a flowchart showing a vehicle routing method according to SA.

FIG. 7 is an application interface of a vehicle routing device.

FIG. 8 is another application interface of a vehicle routing device.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of examples and not by way of limitation. Several definitions that apply throughout this disclosure will now be presented. It should be noted that references to “an” or “one” embodiment in this disclosure are not necessarily to the same embodiment, and such references mean “at least one.”

The term “comprising” means “including, but not necessarily limited to”; it specifically indicates open-ended inclusion or membership in a so-described combination, group, series and the like.

The present disclosure pertains to system and method for finding optimal or near optimal depot locations and/or vehicle routes to serve a set of customers in a distribution system. For example, it is required to visit a subset of customer vertices to satisfy their specific demands or specific time window of customers (available for receiving delivery shipments) while minimizing the total distance traveled. Therefore, the system and method in accordance with the instant disclosure may provide decisions on whether a depot is to be opened or closed, whether a delivery vehicle is available for courier assignments to the opened depots, and which delivery routes to be constructed to fulfill the demand.

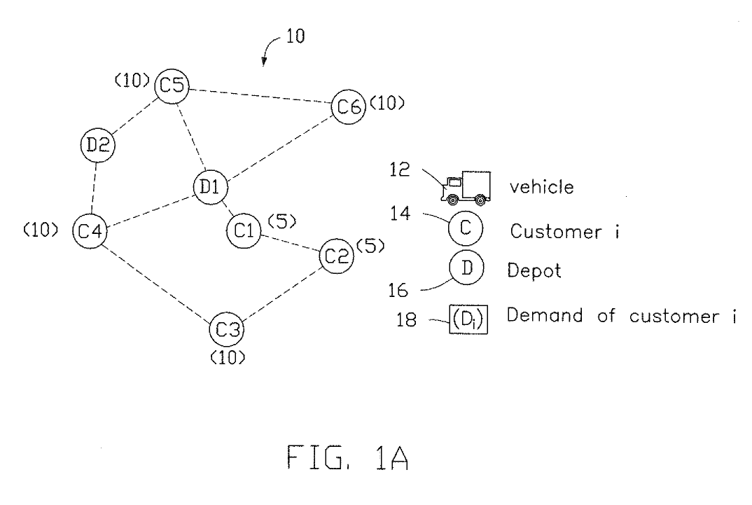

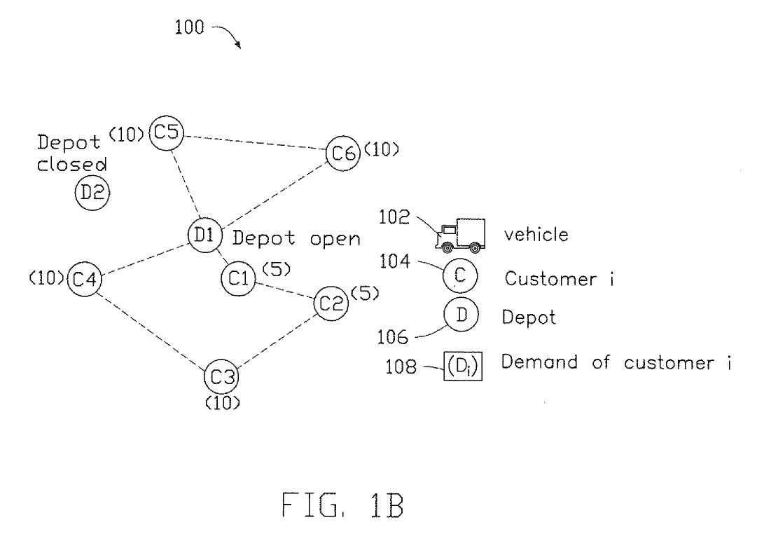

FIG. 1A is an illustration of an example distribution system 10. The exemplary distribution system 10 may comprise one or more delivery vehicles 12, a plurality of customers 14, a plurality of depots 16 to address a plurality of customer demands (Di) 18. In some embodiment, the depots may be pre-arranged before the distribution system 10 operating in an area. For example, D1 and D2 should be considered which one should be opened or both should be opened.

FIG. 1B is an illustration of an example distribution system 100. The exemplary distribution system 100 may comprise one or more delivery vehicles 102, a plurality of customers 104, a plurality of depots 106 to address a plurality of customer demands (Di) 108.

Each vehicle 102 provides a predetermined shipment carrying capacity and has vehicle activation cost. Each customer 104 is associated with customer demands 108, a location coordinate, a service time, and/or an available time window for receiving delivery shipments. Each depot 106 is associated with an opening cost, a location coordinate, a storage capacity and an opening time/closing time.

In at least one embodiment, the vehicle 102 may start and end at the same depot 106. For example, if the vehicle 102 starts from depot D1, then it end/stop at depot D1. The vehicle can't stop at depot D2, D3, or D4. Another vehicle 102 may start from a different depot 106, but it stops or end at its' starting depot. For example, the vehicle 102 starts from depot D2, then it end/stop at depot D2.

In at least one embodiment, the vehicle 102 may start and end at a different depot 106. For example, if vehicle 102 starts from depot D1, then it end/stop at depot D2, D3, or D4.

Another vehicle may start from a different depot, but it must stop or end at its' starting depot. For example, another vehicle, say vehicle 2, may start from depot 2. But it must stop/end at depot 2.

For an exemplary scenario where depot D1 is opened and depot D2 is closed. The vehicle 102 with a holding capacity of 30 shipments may upload 30 shipments in D1 and choose route 1 (D1-C1-C2-C3-C4-D1) to go on a first round trip. The vehicle 102 may unload 5 shipments in C1, 5 shipments in C2, 10 shipments in C3, 10 shipments in C4, and head back to D1. The vehicle 102 may then upload 20 shipments in D1 and choose route 2 (D1-C5-C6-D1) to go on a second round trip. The vehicle 102 unloads 10 shipments in C5, 10 shipments in C6, and goes back to D1. In some embodiments, the vehicle 102 can choose other routes (such as D1-C4-C5-C6-D1) in order to satisfy different objectives, such as minimizing total distance traveled, total time traveled or total distribution network costs. In some embodiments, numbers of vehicles 102 can be applied in the distribution system 100.

Specifically, one of the objectives for minimizing the total distribution network costs may include “depot opening cost” and “routing cost,” i.e. travel cost and fixed cost. Decisions may be made as to which depots should be opened, as to how many vehicles should be operated, and as to how the operated vehicles may serve all customers under routing and capacity constraints.

In some embodiments, the number of vehicles is abundant, and one customer can only be served by one vehicle. In some embodiments, depot capacity and demand are deterministic, and each customer or each depot has deterministic time windows. In some embodiments, each customer or each depot has deterministic time constraints

The vehicle routing method in accordance with the instant disclosure may be adopted by a variety of distribution network applications other than delivery networks, for example, the newspaper distribution network, waste collection network, food and drink distribution network, medical service network, and the like.

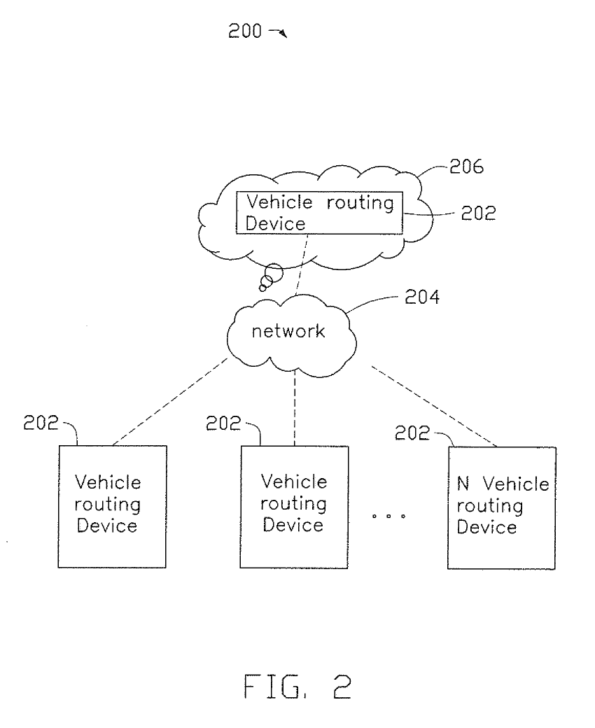

FIG. 2 shows a vehicle routing system. The exemplary vehicle routing system 200 comprises a plurality of vehicle routing device 202 (in the instant case, N devices) communicatively coupled with each other through the network 204 (e.g., the Internet). The vehicle routing device 202 can be located in the depots, the vehicles, or carried by the customers. All the routing information and data (such as vehicle routing plan) can be exchanged among the depots, the vehicles, or the customers through the vehicle routing device 202. In some embodiments, the vehicle routing device 202 can be set in a cloud center where the cloud center can receive all the routing information from the depots, the vehicles, or the customers. For example, the routing devices 202 in the depots may be configured to provide depot capacity or depot time window information; the routing device 202 in the vehicles may be adopted to provide vehicle capacity or vehicle availability information; and routing devices 202 carried by the customers may be configured to provide order information or customer time window information. The cloud center may be arranged to receive the routing information and make optimal vehicle routing plans accordingly.

In at least one embodiment, the routing device is in a cloud center 206.

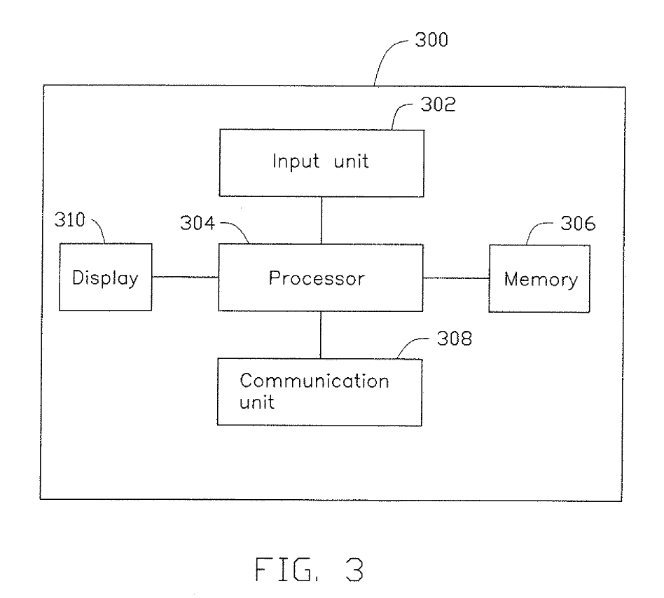

FIG. 3 shows an exemplary vehicle routing device 300 adaptable in the vehicle routing system 200 as shown in FIG. 2. The vehicle routing device 300 comprises a processor 304 configured to generate at least one operation solution based on a routing information. An input unit 302 is coupled to the processor 304 and configured to inputting routing information. The input unit 320 may be any suitable electronic device that includes an input interface configured to receive an input data/information (e.g., cellular telephone, personal digital assistant (PDA), laptop, radio, broadcasting, walkie-talkie, etc.). A memory 306 is coupled to the processor 304 and configured to receive and store the routing information. The memory 306 may comprise some instructions (executed by software, firmware or programs) executable by the processor 304. The memory 306 may comprise a volatile or a non-volatile memory device such as a flash memory, a read only memory (ROM), or a random access memory (RAM), and actual implementation of the memory device should not limited to these examples. A display 310 is coupled to the processor 304 and configured to display information that shows the operation instructions and a visual representation of the operation solution on vehicle routing information (for example, displaying a vehicle routing plan). The display 310 may be an electronic device that includes an output unit, such as a monitor, cellular telephone, personal digital assistant (PDA), laptop, radio, broadcasting, walkie-talkie, etc. A communication unit 308 is coupled to the processor 304 and configured to transmit or receive any routing information.

In at least one embodiment, the vehicle routing device 300 is arranged in a depot. A staff in the depot may input the objective information and depot information through the input unit 302 (in some embodiment, the objective information comprising minimizing the total cost of distribution network/system is pre-stored in the memory 306, and the depot information is pre-stored in the memory 306). The commination unit 308 is configured receive vehicle information from vehicles and customer information from customers as routing information. The objective information and the routing information may be stored in the memory 306 or be transmitted to the processor 304 directly. The processor 304 is configured to execute a program to generate a vehicle routing plan based on the routing information and the objective information. The vehicle routing plan can be shown on the display 310 to the staff in the depot and is also transmitted to the vehicles and customers through the commination unit 308. Therefore, arrangement on vehicle routing is updated. In some embodiment, vehicles, customers or cloud centers also may operate the vehicle routing devices 300. In at least one embodiment, the vehicle routing device 300 is mainly operated in the cloud center to generate a vehicle routing plan. The objective function (or objective information) can be preinstall in the vehicle routing device 300 in the cloud center or be input manually by anyone who operates the vehicle routing device 300. The depots, the vehicles and the customers provide their information to the cloud center and receive the vehicle routing plan performed by the cloud center afterward.

In at least one embodiment, the vehicle routing device 300 is arranged in a cloud center, wherein the communication unit 308 is available for exchanging routing information among the vehicles, depots, and customers. The process of generating vehicle routing plan are in the cloud center. For example, the vehicle routing device 300 is operated in a cloud center and is configures to receive the routing information from any devices (such as mobile phone, PDA, etc.) in vehicles, depots and customers by the communication unit 308. After a vehicle routing plan is generated by the processor 304. The communication unit 308 is configured to transmit the vehicle routing plan to any devices (such as mobile phone, PDA, etc.) in vehicles, depots and customers from the cloud center.

Because some information may be dynamic, the vehicle routing plan may be changed according to the objective information and conditions of the depots, the vehicles and the customers. For example, when a vehicle has an accident and is not available to work, the vehicle will update vehicle information to the system so that the vehicle routing device/system may make a new vehicle routing plan dynamically in accordance with the updated information.

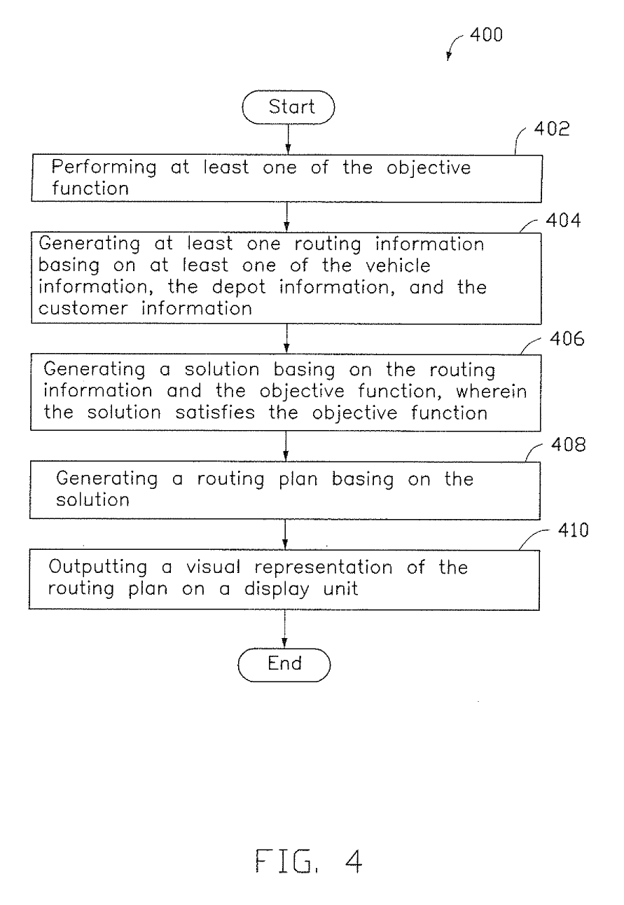

FIG. 4 is a flowchart 400 as one embodiment showing a vehicle routing or depot locating method.

In block 402, performing at least one of the objective function (or objective information) via the input unit 302 or preinstalled in the memory 306. The objective function may comprise minimizing total distance traveled, total time traveled or total distribution network costs.

In block 404, generating at least one routing information basing on at least one of the depot information, the vehicle information and the customer information via the processor 304. The depot information may be provided from depots, wherein the depots information may comprise capacity of the depots or time window of the depots. The vehicle information may be provided from vehicles available in a vehicle routing system (e.g., a shipment distribution network.). The customer information may be provided form customers who give an order or when the shipment is available to be delivered. When receiving the information from the depots, the vehicle and customers, the information are original information, wherein the original information are randomly arranged without being modified optimally. Therefore, an optimal solution for a vehicle routing plan based on the objective information is necessary.

In block 406, generating a solution based on the routing information and the objective information, wherein the solution satisfies the objective function by the processor 304. The objective function may have a criteria for the solution to be certificated. If the solution matches the criteria, the solution can be chosen as optimal or near optimal solution.

In block 408, generating a vehicle routing plan basing on the solution by the processor 304. The vehicle routing plan helps the vehicles to reschedule their routes in order to satisfy the objectives, such as minimizing total distance traveled, total time traveled or total distribution network costs.

In block 410, outputting a visual representation of the vehicle routing plan on a display unit.

In some embodiment, the vehicle routing plan comprises a depot locating plan. The depot locating plan can be generated basing on the solution by the processor 304. The depot locating plan provides an arrangement plan for where the depots should be locate in order to satisfy the objectives, such as minimizing total distance traveled, total time traveled or total distribution network costs.

In some embodiment, a depot locating plan can be generated basing on the solution by the processor 304 with depot locating method. For example, when evaluating where to operate the depots, there may have numbers of locations can be chosen. The depot locating plan provides an arrangement plan for where the depots should be locate in order to satisfy the objectives, such as minimizing total distance traveled, total time traveled or total distribution network costs. Therefore, the depots can be considered where to be operated.

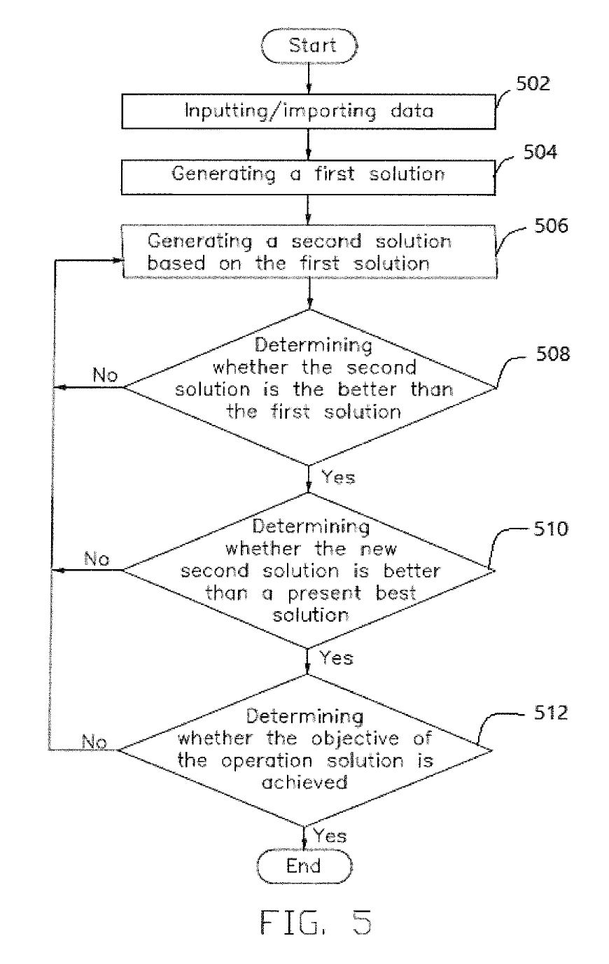

Referring to FIG. 5 as one embodiment of an instruction to generate the solution according to the block 406. For example, the first solution (initial solution) is provided by Greedy algorithm. The instruction is able to generate a second solution based on the first solution. For example, the second solution is provided by using a simulated annealing algorithm (SA). The SA is a local search-based heuristic capable of escaping from being trapped at a local optimum by accepting, with small probability tolerances, worse solutions during its search for the optimal solution. The optimization procedure of the SA searches for a (near) global minimum mimicking a slow cooling procedure in a physical annealing process. Starting from an initial solution by greedy algorithm, a new solution is taken from the predefined neighborhood of the current solution at each iteration.

In block 502, the instruction is able to input or import data. In block 504, the instruction is able to generate a first solution. In block 506, the instruction is able to generate a second solution based on the first solution. In block 508, the instruction is able to evaluate and determine whether the second solution is better than the first solution. If the second solution is better than the first solution, then the process is going to next evaluation. In block 510, the instruction is able to evaluate and determine whether the second solution is better than the present best solution. If the second solution is better than the present best solution, then generate a new second solution which replaces the present best solution. In block 512, the instruction is able to determine whether the objective of the operation solution is achieved.

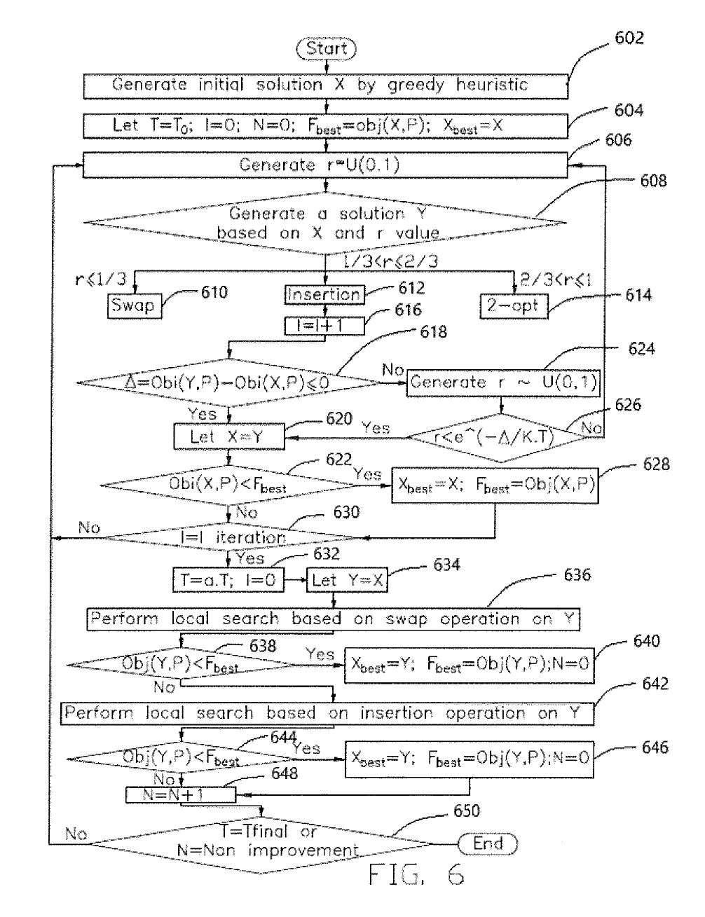

FIG. 6 illustrates the detailed flow chart of SA for vehicle routing considering time window, wherein the objective may comprises “minimize total distance” or “minimize total distribution network costs”.

The flow chart begins by setting current temperature T to T₀ and generating an initial solution X by greedy heuristic algorithm in block 602. The current best solution, X_{best}, and the best objective function of X, denoted by F_{best}, are set to be X and Obj(X) in block 604, respectively. A random value r is generated in block 606. For each iteration, a new solution Y is obtained from pre-defined neighborhoods of the current solution X in block 608. The objective function values of X and Y are then evaluated. The r is related to corresponding block 610 (Swap, r≦⅓), block 612 (Insertion, ⅓<r≦⅔) and block 614 (2-opt, ⅔≦r≦1). For example, if value of r is between ⅓ and ⅔ (⅓<r≦⅔), then insertion in block 612 is chosen and iteration (I=I+1) in block 616 is defined.

In block 618, suppose Δ=obj(Y)−obj(X). If Δ is less than or equal to zero, then it means that Y is better than X, and therefore X is replaced with Y in block 620; otherwise, the probability (value of r is generated again in block 624) of replacing X with Y is exp(−Δ/KT). If value of r is less than exp(−Δ/KT) in block 626, X is replaced with Y in block 620. In block 622, If Obj(X,P) is less than F_{best}, then it means that X_{best}=X and F_{best}=Obj(X,P) in block 628; otherwise, it decides whether iteration (I=I) in block 630. The current temperature T is then decreased after running I, using the formula T=αT in block 632 and make Y=X in block 634. For example, the current temperature T is then decreased after running Iᵢₜₑᵣₐₜᵢₒₙ (5000 iterations), using the formula T=αT, where α=0.98.

Furthermore, set Y as X_{best} and then perform the local search based on the swap operation in block 636, block 638 (decision on if Obj(Y,P)<F_{best}) and block 640 (X_{best}=Y, F_{best}=Obj(Y,P) and N=0). Then set Y as X_{best} and then perform the local search based on the insertion operation in block 642, block 644 (decision on if Obj(Y,P)<F_{best}), block 646 (X_{best}=Y, F_{best}=Obj(Y,P) and N=0) and block 648 (N=N+1). The algorithm is terminated when the current temperature T is lower than T_{final} or current best solution X_{best} has not improved for N_{non-improving} consecutive temperature reductions in block 650.

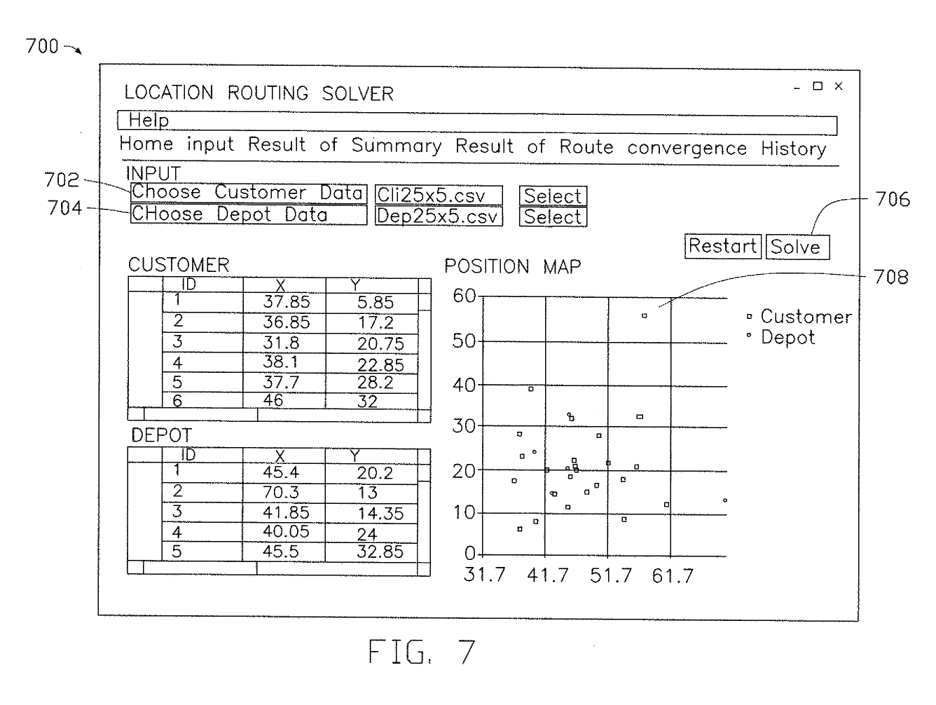

FIG. 7 illustrates an embodiment of an interface 700 of a vehicle routing device. A first input field 702 is configured to select and upload customer data or customer information. A second input field 704 is configured to select and upload depot data or depot information. After inputting the depot information and the customer information, a position map 708 illustrates the position of the depots and the customers. The program will be executed after the solve button 706 being pressed. In some embodiment, vehicle information can be selected and uploaded in the interface 700.

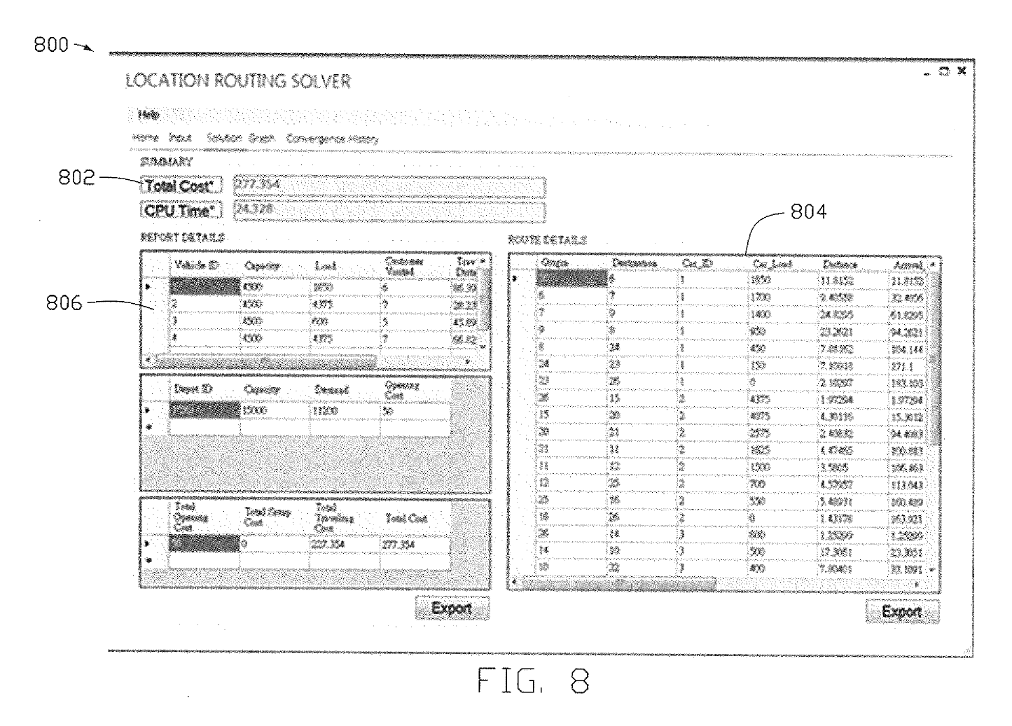

FIG. 8 illustrates another embodiment of an interface 800 of a vehicle routing device. A first output field 802 shows total cost as an objective after the program being executed. A window 804 and a report 806 show a vehicle routing plan after the program being executed. The vehicle routing plan comprises every vehicle routing information including the vehicle identification, the vehicle load, the vehicle capacity, the vehicle traveled distance, and the vehicle setup cost, number of customers visited by the vehicles. The vehicle routing plan also comprises depot information including the depot identification, the depot capacity, the depot demand, and opening cost. The vehicle routing plan also comprises cost information including total opening cost, total set up cost, total traveling cost, and total cost.

The embodiments shown and described above are only examples. Many details are often found in the art such as the other features of a vehicle scheduling device and method for transportation system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A vehicle routing device comprising:
a processor configured to perform at least one objective function;
an input unit communicatively coupled to the processor and configured to accept input information that includes at least one of a vehicle information, a depot information, and a customer information;
a computer readable medium coupled to the processor, the computer readable medium comprising instructions stored therein which, upon execution by the processor, causes the processor to perform operations comprising:
performing at least one of the objective function;
generating at least one routing information basing on at least one of the vehicle information, the depot information, and the customer information;
generating a solution basing on the routing information and the objective function, wherein the solution satisfies the objective function;
generating a vehicle routing plan basing on the solution; and
a display unit coupled to the processor and configured to output a visual representation of the vehicle routing plan.

2. The vehicle routing device of claim 1, wherein the vehicle routing plan comprises a depot locating plan which provides an arrangement plan for where the depots where should be operated.

3. The vehicle routing device of claim 1, wherein the solution is generated based on a simulated annealing algorithm (SA).

4. The vehicle routing device of claim 1, further comprising a communication unit configured to receive and transmit the routing information and the vehicle routing plan.

5. The vehicle routing device of claim 1, wherein the depot information comprises at least one of a depot capacity information and depot time window information.

6. The vehicle routing device of claim 1, wherein the vehicle information comprises at least one of a vehicle capacity information and available vehicle on duty information.

7. The vehicle routing device of claim 1, wherein the customer information comprises at least one of an order information and customer time window information.

8. The vehicle routing device of claim 1, wherein the objective function comprises at least one of a minimizing total distance traveled objective option, a minimizing total time traveled objective option, and a minimizing total distribution network costs objective option.

9. The vehicle routing device of claim 1, wherein the vehicle information, the depot information, and the customer information are pre-stored in the computer readable medium.

10. The vehicle routing device of claim 1, wherein the vehicle routing plan comprises vehicle routing information comprising at least one of a vehicle identification, a vehicle load, a vehicle capacity, a vehicle traveled distance, a vehicle setup cost, number of customers visited by the vehicles.

11. A distribution system comprising:
at least one vehicle;
at least one depot configured to provide depot information;
at least one customer configured to provide customer information;
at least one cloud center coupled to the vehicle, the depot and the customer via an internet, wherein at least one vehicle routing device is set in the cloud center, comprising:
a processor configured to perform at least one objective function;
an input unit communicatively coupled to the processor and configured to accept input of at least one of the depot information, and the customer information;
a computer readable medium coupled to the processor and configured to receive the routing information, the computer readable medium further comprising instructions stored therein which, upon execution by the processor, causes the processor to perform operations comprising:
providing at least one objective information;
generating at least one routing information basing on at least one of the depot information, and the customer information;
generating a solution basing on the routing information and the objective information, wherein the solution satisfies the objective information;
generating a vehicle routing plan basing on the solution; and
a display unit coupled to the processor and configured to output a visual representation of the vehicle routing plan.

12. The distribution system of claim 11, wherein the routing plan comprises a depot locating plan which provides an arrangement plan for where the depots where should be operated.

13. The distribution system of claim 11, wherein the solution is generated based on a simulated annealing algorithm (SA).

14. The distribution system of claim 11, wherein at least one vehicle routing device is set in the depot.

15. The distribution system of claim 11, wherein the routing information further comprises a vehicle information.

16. The distribution system of claim 11, further comprising a communication unit which is configured to receive and transmit the routing information and the vehicle routing plan.

17. A vehicle routing method performed by a distribution system, comprising:
computer readable medium coupled to the processor, the computer readable medium comprising instructions stored therein which, upon execution by the processor, causes the processor to perform operations comprising:
performing at least one of the objective function;
generating at least one routing information basing on at least one of the vehicle information, the depot information, and the customer information;
generating a solution basing on the routing information and the objective function, wherein the solution satisfies the objective function;
generating a routing plan basing on the solution; and
outputting a visual representation of the vehicle routing plan on a display unit.

18. The vehicle routing method of claim 17, wherein the routing plan comprises a depot locating plan which provides an arrangement plan for where the depots where should be operated.

19. The vehicle routing method of claim 17, further comprising a step of transmitting the routing plan through a communication unit.

20. The vehicle routing method of claim 17, wherein the solution is generated based on a simulated annealing algorithm (SA).
